(19) United States
(12) Patent Application Publication
(10) Pub. No.: US 2018/0322803 A1
(43) Pub. Date: Nov. 8, 2018

(54) METHOD OF REPRESENTING THE SEQUENCE OF WRITING OF STROKES FOR CHARACTERS IN FAR EAST SYLLABIC LANGUAGES

(71) Applicant: TOMASZ WOJCIECH JAWORSKI, TAINAN (TW)

(72) Inventor: TOMASZ WOJCIECH JAWORSKI, TAINAN (TW)

(21) Appl. No.: 15/588,577

(22) Filed: May 5, 2017

(51) Int. Cl. G09B 11/00; G09B 5/06

(52) U.S. Cl. CPC G09B 11/00; G09B 5/065

(57) ABSTRACT

Disclosed is a method of using the progressive color scheme such as a rainbow color order to represent the writing stroke order of the Chinese type character. In addition it discloses a method that uses dots to indicate the starting point of each stroke and a method to indicate which strokes belonging to the radical of the Chinese character and which strokes belonging to the remaining parts of the character by different colors of these dots.

### BACKGROUND

### Field of Invention

Many Far East languages are written in syllabic scripts that utilize stroke based writing style for each character (Ex. Chinese Traditional and Simplified characters). In those types of languages the writing stroke order is deemed important and so it is thought to students. This invention relates to the method of representing the sequence of strokes for writing characters in Far East syllabic languages in a more concise and intuitive way.

### FEDERALLY SPONSORED REASEARCH

None

### SEQUENCE LISTING

None

### BACKGROUND

### Description of the Prior Art

At the present time the method of representing the stroke order for character in Far East syllabic languages is based on a series of images showing the subsequent stages of writing of a character. The above method requires a large number of images and takes a lot of space in printed materials.

Another method is based on animation and requires usage of the media that are able to perform such an animation.

Yet another is based on numbering the strokes with small numerals next to each stroke. This method works well for characters with just a few strokes, but for characters with many strokes the image quickly becomes too cluttered to be easily recognizable. The present invention utilizes a progressive color scheme to represent the writing stroke order of such characters as well as stroke order indicator dots. Consequently it makes it possible to show the order of strokes, direction of strokes and differentiate the strokes belonging to the radical and to the remaining strokes of such a character. All this information may be contained in only one simple and intuitive image.

### SUMMARY OF INVENTION

The general idea of the present invention is utilizing a proressie color scheme such as rainbow color order to represent the writing stroke order for character in Far East syllabic languages. It also may utilize a dot to indicate the starting point of each stroke and hence its direction. Two different colors of dots may be used to indicate the strokes belonging to the radical and to the remaining strokes of such a character.

### OBJECTIVES AND ADVANTAGES

Several objectives and advantages are:
1. The ability to indicate the sequence of writing of the strokes for characters in Far East syllabic languages by an intuitive progressive color scheme (such as rainbow color order).
2. The ability to provide an additional clue to the order of strokes by proper stroke layering with the later stoke color overlaying earlier strokes where the strokes overlap.
3. The ability to indicate the direction of writing of strokes in such a character by placing a dot on the starting point of the stroke.
4. The ability to indicate the radical strokes and the remaining strokes of such a character by using different colors for the starting point dots marking the direction of the stroke.
5. The ability to partition the use of colors for characters with large amount of strokes, in such a way as to color the strokes that are part of each sub-character with overlapping ranges of colors, to reduce the number of total colors used in order to make the stroke order more readable. See example in FIG. 2 for the Chinese character for “Speak” (shuō), which has 14 strokes, but would only require 8 distinct colors to represent the stroke order. Note that the 1^{st} stroke of the 1^{st} sub-character is colored starting with the 1^{st} color in the rainbow sequence, and the 1^{st} stroke of the 2^{nd} sub-character is colored starting with the 2^{nd} color in rainbow sequence, in that way we can encode the order of writing of the sub-characters.
6. The ability to show all the information enumerated above using only one image of the character in a Far East syllabic language instead of a series of the images showing the consecutive stages of writing that character.

Due to above advantages this method may be very useful for teaching the writing of characters for Far East syllabic languages such as the Chinese characters.

### BRIEF DESCRIPTION OF THE DRAWINGS

FIG. 1 shows the Chinese Character for “Cold” (lěng). This character consists of 7 strokes (2 strokes in radical and 5 remaining strokes), and is shown colored using 7 colors in rainbow order: red, orange, yellow, green, cyan, blue and magenta.

FIG. 2 shows the Chinese Character for “Speak” (shuō). This character consists of 14 strokes (7 strokes in radical and 7 remaining strokes), and is shown colored using 8 colors in rainbow order: red, orange, yellow, green, cyan, blue, purple and magenta.

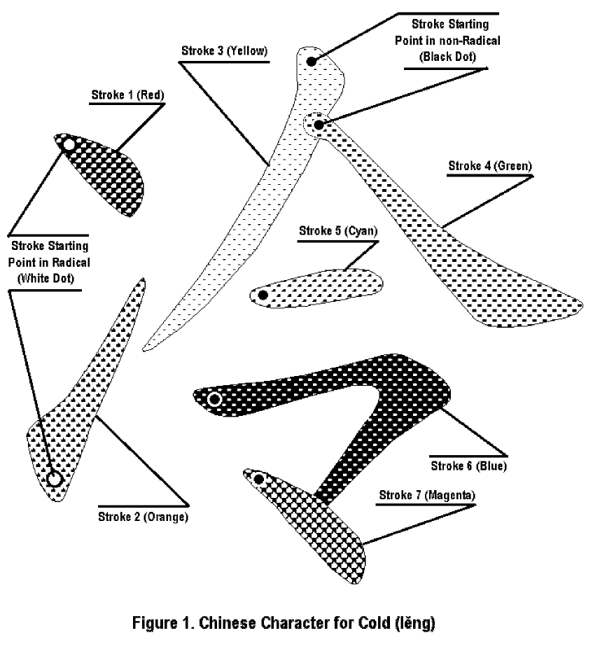

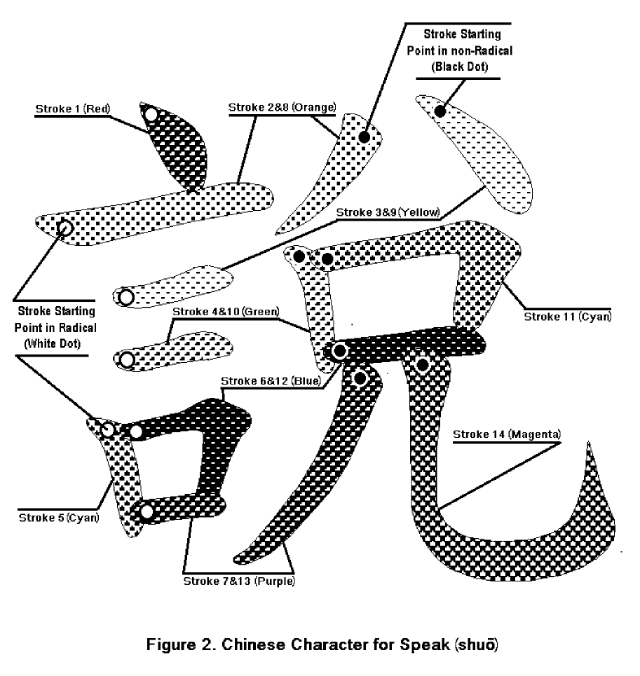

### DETAILED DESCRIPTION—FIG. 1—PREFERRED EMBODIMENT

Herein, there follows the description of the present invention in its embodiment. Referring to FIG. 1 the Chinese character is shown with the strokes 1, 2, 3, 4, 5, 6 and 7 marked with the colors in a progressive color scheme of the rainbow where the strokes 1, 2, 3, 4, 5, 6 and 7 are shown in rainbow color order i.e.: red, orange, yellow, green, cyan, blue and magenta respectively. The dots on strokes 1, 2, 3, 4, 5, 6 and 7 are indicating the starting point of each stroke. The dots on strokes 1 and 2 are white showing the radical part of the Chinese character and the dots on strokes 3, 4, 5, 6 and 7 are black showing the remaining strokes of the Chinese character.

### CONCLUSION, RAMIFICATION AND SCOPE

The invention relates to the method of representation of the writing sequence of strokes in Chinese type characters with additional indications of strokes starring point determining the stroke writing direction. The different colors of these starting points may indicate the strokes belonging to the radical of the Chinese character and the remaining strokes of this character.

The particular embodiment has been illustrated and described in example only and is not intended to be limiting. It will be apparent to those skilled in art that various changes and modification can be made without departing from the scope of the present invention. It is therefore to encompass within the appended claims all such changes and modifications, that fall within the scope of the present invention.

What is claimed is:

1. A method utilizing a progressive color scheme to represent writing stroke order of Far East syllabic characters such as Chinese characters.

2. The method of claim 1 wherein said progressive color scheme is a rainbow color order.

3. The method of claim 1 using a dot placed near the starting point of each said stroke to indicate the starting point and hence the direction of writing of said stroke.

4. The method of claim 3 using two different colors for said dots indicating said starting point of said stroke, where said strokes marked with said dot in a first said color indicates said strokes belonging to the radical of said character and said strokes marked with dot in a second said color indicates said strokes belonging to any remaining said strokes of said character, if any.

5. The method of claim 4, wherein said two different colors are black and white.

6-10. (canceled)

11. Printed material utilizing the method of claim 1.

12. Video material utilizing the method of claim 1.

13. Electronic program utilizing the method of claim 1.

14. Printed material utilizing the methods of claim 2.

15. Video material utilizing the methods of claim 2.

16. Electronic program utilizing the methods of claim 2.

17. Printed material utilizing the methods of claim 3.

18. Video material utilizing the methods of claim 3.

19. Electronic program utilizing the methods of claim 3.

20. Printed material utilizing the methods of claim 4.

21. Video material utilizing the methods of claim 4.

22. Electronic program utilizing the methods of claim 4.

23. Printed material utilizing the methods of claim 5.

24. Video material utilizing the methods of claim 5.

25. Electronic program utilizing the methods of claim 5.
